(19) United States
(12) Patent Application Publication
(10) Pub. No.: US 2026/0067162 A1
(43) Pub. Date: Mar. 5, 2026

(54) LANGUAGE MODEL TRANSFORMER FOR CROSS-PLATFORM CONFIGURATION AND SCRIPT CONVERSION

(71) Applicant: CDW LLC, Vernon Hills, IL (US)

(72) Inventor: Carl Gruber, Fond du Lac, WI (US)

(21) Appl. No.: 18/817,179

(22) Filed: Aug. 27, 2024

(51) Int. Cl. H04L 41/084; H04L 41/0869

(52) U.S. Cl. CPC H04L 41/084; H04L 41/0869

(57) ABSTRACT

A computing system and method are disclosed for converting network configurations across different platforms using a language model. This system preprocesses a source network configuration from a first network platform, generates a prompt based on the preprocessed source network configuration and additional network data for input to the language model. In response to the prompt, the language model converts the source network configuration into a target network configuration for a second platform, ensuring that common configuration elements are preserved while unsupported protocols are adapted to supported alternatives on the second network platform. The system outputs the converted configuration, facilitating seamless network migration with minimal, or no, manual intervention. Additional features include the ability to receive and process active device states and network diagrams, suggesting alternative solutions for unsupported protocols, validating the target configuration against the second platform's specifications, and interacting with users to refine the conversion based on their input.

### FIELD OF THE DISCLOSURE

The present disclosure is directed to a language model transformer for cross-platform configuration and script conversion, and more particularly, to methods and systems for cross-platform configuration conversion using a language model.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the field of networking and information technology, organizations often face the challenge of migrating configurations from one networking platform to another. This might be due to various reasons, including but not limited to, changes in vendor preferences, upgrades in technology, and shifts in corporate strategy. Existing tools and methods for platform configuration conversion typically require extensive manual intervention, deep expertise in multiple vendor technologies, and significant time investment. The complexity is further compounded when configurations need to be adapted to support features or protocols not directly transferable between platforms, necessitating not just a translation of configurations but also a reimagining of network design to accommodate technological disparities.

Moreover, the traditional approach to network configuration conversion often relies on static tools that lack the flexibility to incorporate specific operational requirements or adapt to unique network architectures without extensive custom coding or manual configuration. These tools may not efficiently handle scenarios where new network features need to be integrated during the conversion process, or when there's a need to suggest alternatives for unsupported protocols across different platforms. Additionally, the reliance on these methods can restrict the ability of IT personnel to efficiently manage network transformations, especially in environments where resources with expertise in multiple platforms are limited. There is therefore a need for improved platforms and technologies for migrating network configurations from one platform to another.

### BRIEF SUMMARY

In one aspect, a computing system includes: (1) one or more processors; and (2) one or more memories that include computer-executable instructions which, when executed by the one or more processors, cause the computing system to: (3) receive a source network configuration from a first network platform; (4) preprocess the source network configuration based on network data obtained from one or more devices connected to the first network platform; (5) generate a prompt based on the preprocessed source network configuration and additional network data obtained from a network platform data repository; (6) convert, by a language model, the source network configuration into a target network configuration for a second network platform by inputting the prompt into the language model, wherein (i) common configuration elements are maintained and (ii) unsupported protocols are adapted to supported alternatives on the second network platform; and (7) output the target network configuration.

In another aspect, a computer-implemented method includes: (1) receiving a source network configuration from a first network platform; (2) preprocessing the source network configuration based on network data obtained from one or more devices connected to the first network platform; (3) generating a prompt based on the preprocessed source network configuration and additional network data obtained from a network platform data repository; (4) converting, by a language model the source network configuration into a target network configuration for a second network platform by inputting the prompt into the language model, wherein (i) common configuration elements are maintained and (ii) unsupported protocols are adapted to supported alternatives on the second network platform; and (5) outputting the target network configuration.

In yet another aspect, a non-transitory computer-readable medium includes instructions that, when executed by one or more processors of a computing system, cause the computing system to: (1) receive a source network configuration from a first network platform; (2) preprocess the source network configuration based on network data obtained from one or more devices connected to the first network platform; (3) generate a prompt based on the preprocessed source network configuration and additional network data obtained from a network platform data repository; (4) convert, by a language model, the source network configuration into a target network configuration for a second network platform by inputting the prompt into the language model, wherein (i) common configuration elements are maintained and (ii) unsupported protocols are adapted to supported alternatives on the second network platform; and (5) output the target network configuration.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment in which the techniques disclosed herein may be implemented, according to an aspect.

FIG. 2 depicts an exemplary network topology diagram, according to an aspect.

FIG. 3 is a flow diagram of an example method for converting a source network configuration from a first network platform into a target network configuration for a second network platform using a language model.

FIG. 4 depicts an exemplary flow diagram for developing a large language model personal assistant, according to some aspects.

FIG. 5 depicts an exemplary large language model architecture, according to an aspect.

FIG. 6 depicts an exemplary block flow diagram for automated cross platform support and automated error resolution.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Overview

In the realm of networking and information technology, the challenge of migrating network configurations across different platforms is a significant hurdle for organizations. The disclosed computing system leverages a language model transformer for cross-platform configuration and script conversion. This computing system, comprises a client computing device, source and target networks, and various computing devices, and offers a comprehensive approach to simplifying and streamlining the process of network configuration conversion. The following paragraphs provide an overview of the disclosed computing system, focusing on its innovative features and the improvements it brings to cross-platform configuration and script conversion.

The present techniques improve cross-platform configuration conversion through a computing system that utilizes a language model, application programming interfaces (APIs), and a combination of processors and memory resources. This system is adept at autonomously handling the conversion of network configurations from one platform to another, and offers a versatile solution to the challenges associated with network migration. The disclosed techniques include the ability to efficiently preprocess and analyze source network configurations, utilizing the language model to generate prompts based on the preprocessed configurations and additional network data obtained from devices configured for the source network configuration and/or platform. This process not only facilitates the accurate conversion of network configurations but also significantly improves the efficiency of adapting unsupported protocols to supported alternatives on target platforms.

One improvement introduced by this computing system is in processing capabilities. Specifically, the disclosed language model and a language model to API (LM TO API) exchange engine enhance the processing capabilities of the disclosed computing system. Moreover, the language model and the LM TO API interface provide a seamless and robust approach to network configuration conversion that leverages the natural language processing of conventional language models and the plethora of intent-revealing information of active network configurations/platforms that are accessible by APIs, and subsequently reduces the computational load of conventional network configuration conversion systems. This capability is augmented by the system's ability to suggest alternative solutions for unsupported protocols, ensuring that the resulting target network configuration maintains the intended functionality and performance of the original network. Typically, adapting unsupported protocols involves not just a translation of configurations but also a reimagining of network design to accommodate technological disparities by experienced network engineers, thereby requiring significant time and resources to address.

Another significant improvement is in network usage and resource utilization. Through the strategic employment of APIs, the system facilitates seamless communication between the language model and various devices across the source and target networks. This streamlined interaction minimizes unnecessary network traffic, thereby enhancing the efficiency of data retrieval and exchange. Moreover, the system's ability to process and convert network configurations in parallel optimizes the utilization of network resources and maintains high levels of performance and reliability in the computing environment.

In summary, the disclosed computing system introduces significant improvements in processing capabilities and network usage in the context of cross-platform configuration and script conversion. These improvements are achieved through the integration of advanced components, language models, communication interfaces, and specialized APIs. The computing system's ability to efficiently process data, optimize network resources, and adapt unsupported protocols enhances its performance, reliability, and user experience. The present techniques introduce a multifaceted approach to improving the efficiency and accuracy of network configuration conversion across different platforms, offering a robust solution to the challenges faced by organizations in network migration.

### Exemplary Computing Environment

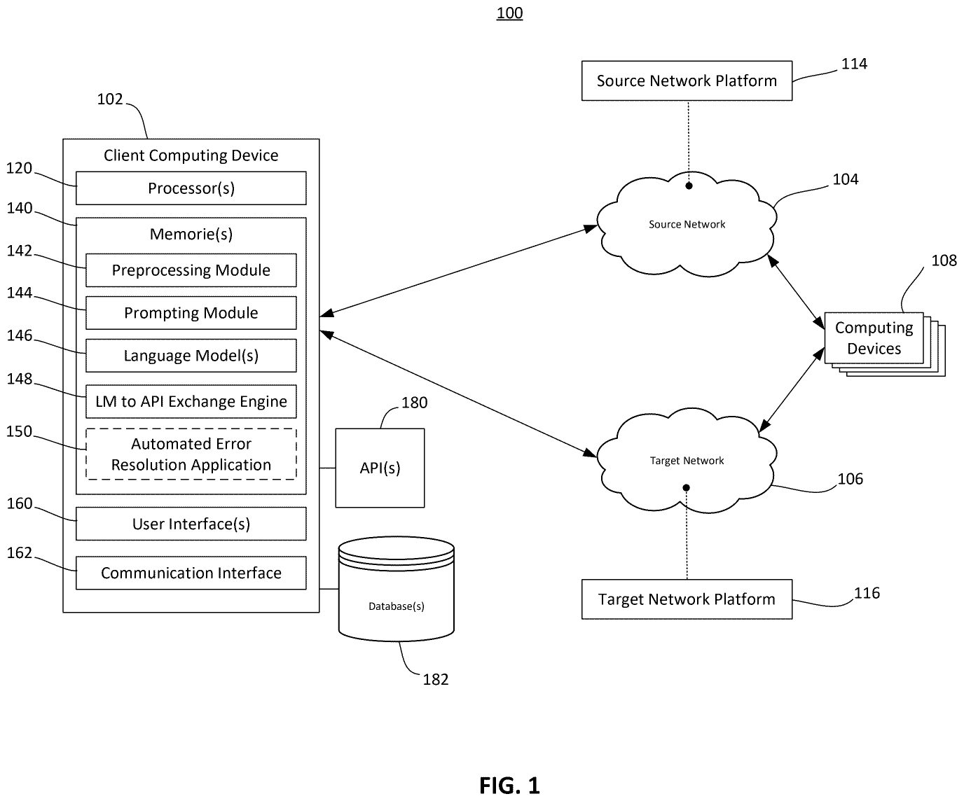

FIG. 1 depicts an exemplary computing environment 100 for converting network configurations between different network platforms while maintaining common configuration elements and adapting unsupported protocols to supported alternatives.

The environment 100 includes a client computing device 102, a source network 104, a target network 106, and two or more computing devices 108. The client computing device 102 includes one or more processors 120, one or more memories 140, one or more user interfaces 160, a communication interface 162, and one or more application programming interfaces (APIs) 180. The source network 104 having a respective source network platform 114, and the target network 106 having a respective target network platform 116. Additionally, the client computing device 102 may be communicatively coupled to one or more databases including at least the database 182 via a network and/or a wired connection.

The client computing device 102 may be an individual server, a group (e.g., cluster) of multiple servers, or another suitable type of computing device or system (e.g., a collection of computing resources). For example, the client computing device 102 may be a mobile computing device (e.g., a server, a mobile computing device, a smart phone, a tablet, a laptop, a wearable device, etc.). In some aspects the client computing device 102 may be a personal portable device of a user. For example, the client computing device 102 may be the property of a customer, a company, an organization, etc.

The client computing device 102 includes a processor 120 and a memory 140. The processor 120 may include any suitable number of processors and/or processor types, such as central processing units (CPUs) and one or more graphics processing units (GPUs). The processor 120 is configured to execute software instructions stored in the memory 140. The memory 140 may include one or more persistent memories (e.g., a hard drive/solid state memory) and store one or more sets of computer executable instructions/modules (e.g., a non-transitory computer-readable medium), including a preprocessing module 142, a prompting module 144, one or more language models 146, a language model to application programming interface (LM to API) exchange engine 148, and in some embodiments, an automated error resolution application 150, as described in more detail below.

The source network 104 is the original network from which the configuration is being converted. The source network 104 is characterized by the source network platform 114, which could be hardware and software solutions provided by vendors such as Cisco, Juniper, Arista, Aruba, etc. The source network 104 includes devices (e.g., the computing devices 108), interfaces, protocols, syntax, and configurations that currently define its operation.

The target network 106 is the new network platform to which the source network 104 is being converted. The computing environment 100 includes components and/or modules (e.g., the preprocessing module 142, the prompting module 144, the one or more language models 146, etc.) for transitioning/converting the source network 104 to the target network 106 and/or upgrading to a newer technology standard. The target network 106 includes a different vendor's hardware/software solutions, as compared to the source network 104. The target network 106 includes devices (e.g., the computing devices 108 and/or additional computing devices, depending on the conversion type), interfaces, protocols, syntax, and configurations. Understanding the architecture and configuration of the source network 104 is essential for accurately translating its setup to the target network platform 116 while preserving the intended functionality and performance. The modules/components of the computing environment 100 analyze the architecture and configuration of the source network 104 in order to recreate the functionality of the source network platform 114 within the constraints and capabilities of the target network platform 116, by adapting or replacing unsupported protocols and configurations as necessary.

The two or more computing devices 108 may be computing devices (e.g., a mobile computing device, a smart phone, a tablet, a laptop, a wearable device, etc.), an individual server, a group (e.g., cluster) of multiple servers/computing devices, or other suitable types of computing devices or systems (e.g., a collection of computing resources). The two or more computing devices 108 may form, and/or be configured for, the source network 104 and/or the target network 106.

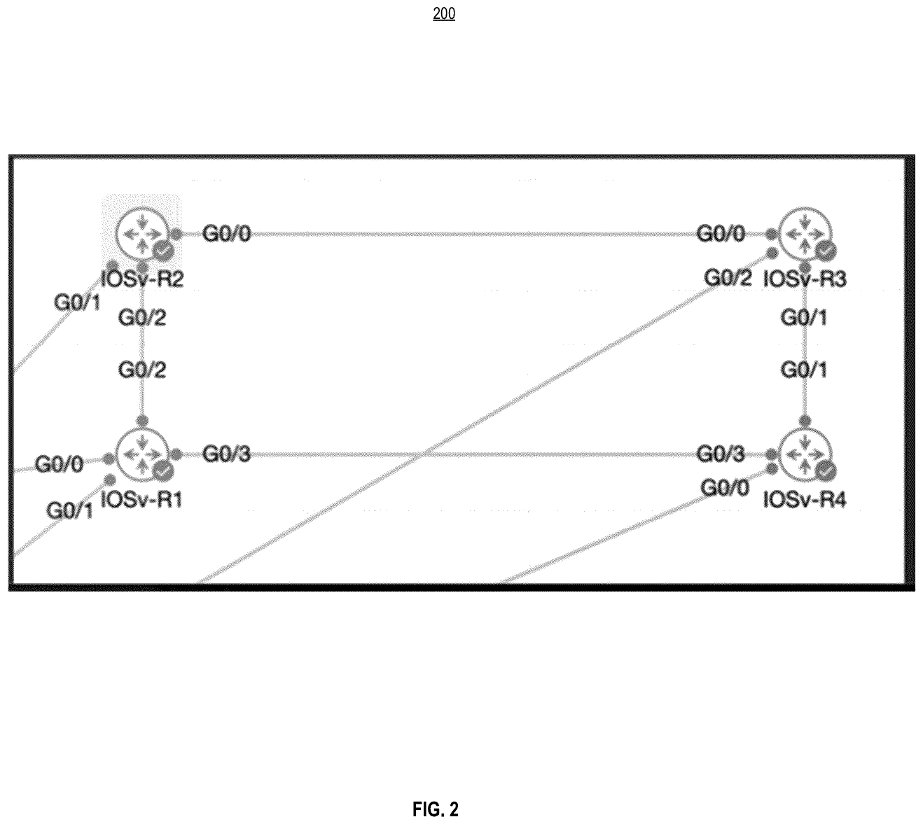

Returning to the client computing device 102, the preprocessing module 142 may include computer-executable instructions for extracting intent-revealing commands from a source network configuration. For example, the preprocessing module 142 may include instructions for analyzing the source network configuration (e.g., configuration of the source network 104) to identify specific commands or settings that indicate the intended functionality or behavior of the source network 104. In some embodiments, the preprocessing module 142 may include instructions for performing a semantic lookup against a data repository (e.g., the database 182) and, in some embodiments, a retrieval augmented generation (RAG) database, to obtain vendor specific configurations/data/protocols for the source network 104, and the source network platform 114 (e.g., and/or the operating system of the source network 104), and data/protocols for the target network 106, and the target network platform 116 (e.g., and/or the operating system of the source network 106). In some embodiments, network diagrams (e.g., network topology diagram 200 of FIG. 2) may additionally be obtained by the preprocessing module 142. Additionally, real-time data may be obtained from the source devices (e.g., in some embodiments, the computing devices 108) by the preprocessing module 142. In some embodiments, a set of network configuration commands (e.g., ‘show running-config’, ‘show interfaces’, ‘show protocols, etc.’), such as commands that set up routing protocols, access control lists, or interface configurations, may be run on one or more devices of the source network 104 (e.g., the two or more computing devices 108). The preprocessing module 142 may cause such commands to be run on the one or more devices of the source network 104 to reveal the source network's intended use, to obtain (e.g., via the APIs 180) the source network's security posture, and to collect relevant real-time configuration data (e.g., data indicative of the configuration(s) actively running on the one or more devices of the source network 104). Such information/data/protocols (e.g., configuration data related to an intended use case, data from the RAG repository and/or database 182, etc.) may be integrated into one or more prompts (e.g., via the prompting module 144) for input to a language model (e.g., the language model 146), thereby expanding the context of the operations and resulting in accurate translation into executable device syntax. The language model may then use the linguistic syntax/knowledge it already possesses, any additional training data (e.g., data from the repository), and the data within the one or more prompts, to accurately associate the query vector, within the prompt, with an answer vector (e.g., mapping, in a multi-dimensional vector space, the query vector present in the prompt to an appropriate answer vector based on knowledge of the model and the additional training data).

The prompting module 144 may include computer-executable instructions for generating prompts based on the preprocessed source network configuration and additional network data, such as, active device states, network interface configurations, network topology diagrams, and/or other network data indicative of the intended use case of associated network configurations that is obtained (e.g., via the APIs 180) from the two or more computing devices 108. The prompting module 144 may generate prompts including sets of instructions that cause the language model 146 to accurately convert a source network configuration into a format compatible with a target network configuration (e.g., for target network platform 116). The intent-revealing commands and additional network data, from the preprocessing module 142, provide the language model 146 with current state data and intended use case information that enables the language model 146 to make informed decisions during the conversion process, ensuring that the resulting target network configuration for the target network 106 aligns with the original network's design and operational requirements (e.g., the design and operational requirements of the source network 104). Additionally, the prompting module 144 may generate a prompt that causes the language model 146 to maintain common configuration elements for the platforms (e.g., the source network platform 114 and the target network platform 116) and adapt unsupported protocols to supported alternatives on the target network platform 116.

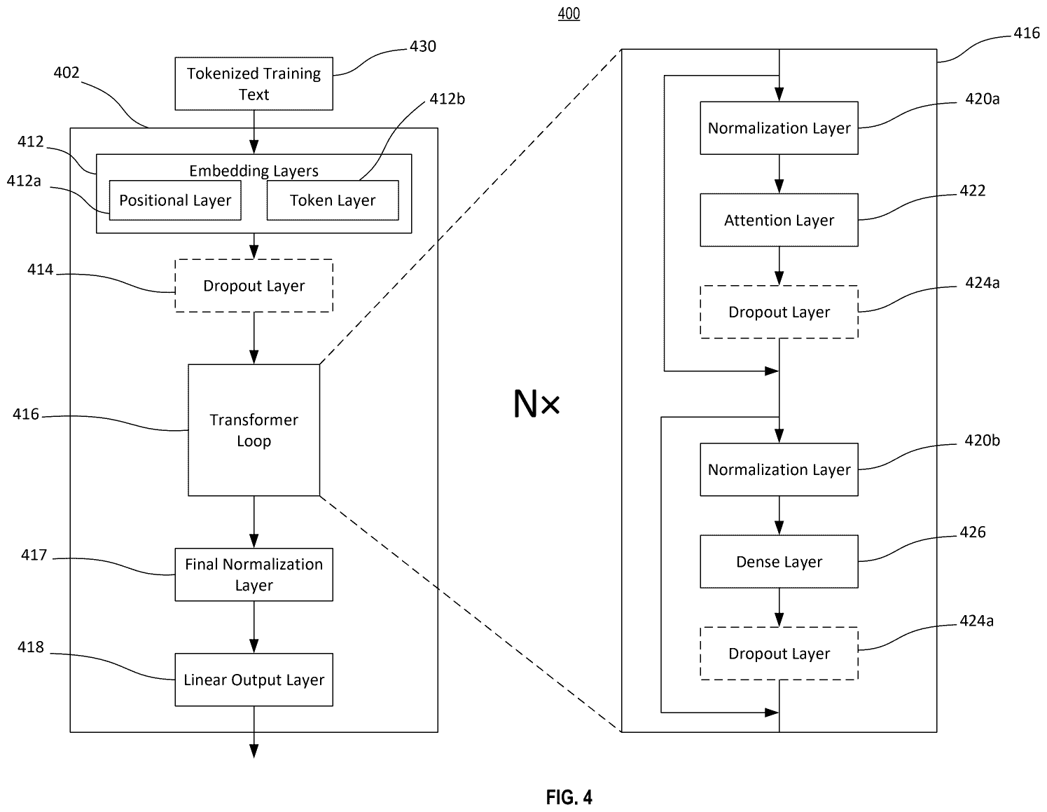

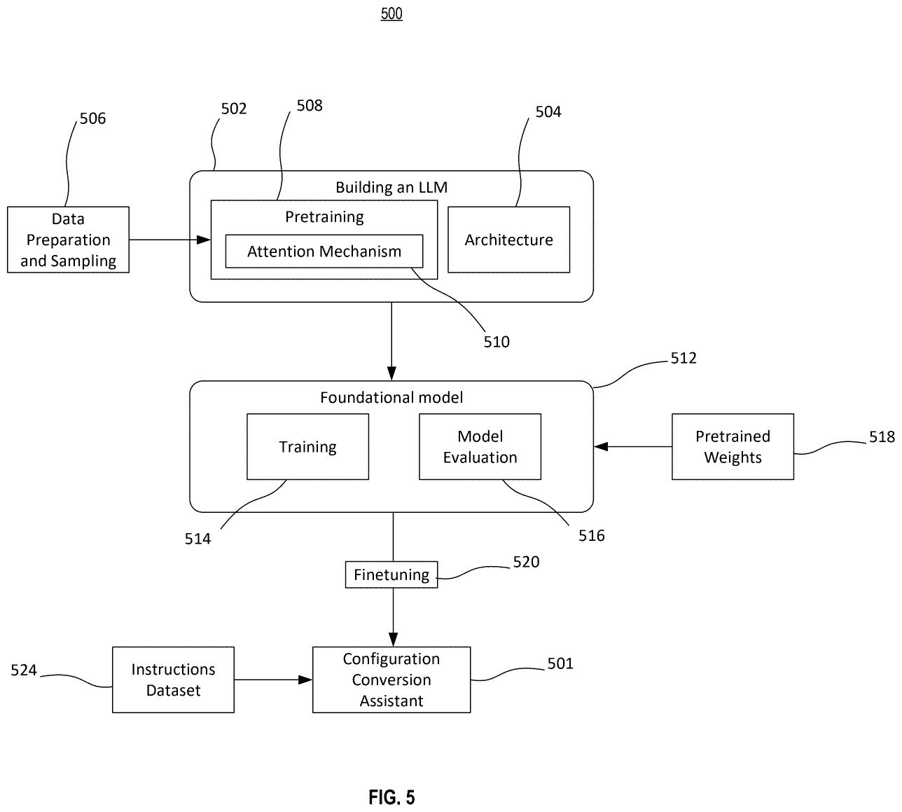

The memories 140 may include one or more language models 146 for implementing the various techniques described herein. The language model 146 may be configured, trained, and/or instructed to generate network configuration scripts. In some embodiments, the language model 146 may be trained on network scripts/protocols associated with example source network platforms and example target network platforms and their respective network configurations. The training/development of the language model 146, or another language model not depicted in FIG. 1, to process user input data, is described below with respect to FIG. 4 and FIG. 5. However, the language model 146, or another language model, may process input data, such as documentation and/or data related to a source network configuration and an associated network platform, a desired target network configuration and an associated network platform, one or more questions and/or queries related to a network configuration and an associated network platform; and generate scripts, protocols, and/or natural language responses, based on such input data.

The memories 140 may additionally include a language model to application programming interface (LM to API) exchange engine 148 for implementing the various techniques described herein. In various embodiments, the LM to API exchange engine 148 may include instructions for obtaining, by an API (e.g., API 180), source network configuration data, such as, source network scripts, source network protocols, etc., from one or more devices (e.g., the two or more devices 108) connected to a source network (e.g., the source network 104) and/or configured for a source network platform (e.g., the source network platform 114). Additionally, the LM to API exchange engine 148 may include instructions for processing (e.g., via the preprocessing module 142) the source network configuration data for input to language model. The LM to API exchange engine 148 may additionally include instructions for inputting one or more prompts generated based upon the source network configuration data to a language model (e.g., the language model 146) and for obtaining responses for the one or more prompts. In some embodiments, the LM to API exchange engine 148 may include instructions for preprocessing (e.g., via the preprocessing module 142) additional network data obtained by an API, such as, active device states, network topology diagrams, network interface configurations, etc., for a source network (e.g., the source network 104) for input to the language model 146. For example, the LM to API exchange engine 148 may include instructions for analyzing one or more network topology diagrams (e.g., network topology diagrams stored in the database 182), or other visual data, for the source network configurations using/by a computer vision API 180 to generate a textual representation or description of the visual data. Further to this end, the LM to API exchange engine 148 may include instructions for inputting, to the language model 146, the textual description for each network topology diagram. Accordingly, meaningful network information included in visual data may be used to further expand the contextual understanding of the language model, thereby improving the language model's ability to generate accurate target network configurations. The LM to API exchange engine 148 may include instructions for processing a target network configuration output by the language model 146 such that the target network configuration may implemented on one or more computing devices (e.g., the two or more computing devices 108).

In some embodiments, the memories 140 may include an automated error resolution (AER) application 150, which may include instructions for automatically detecting an exception/failure state of one or more remote devices (e.g., the one or more devices 104) by monitoring network log files and/or device states directly. The AER application 150 may additionally include instructions for constructing an electronic object corresponding to the exception/failure state, and using the language model 142 to determine a fix for the issue. In some embodiments, using the language model 142 to determine a fix includes generating configuration data/code that will be run on the one or more remote devices to effect a repair/change to cause the failing device to transition into a non-fail state. The AER application 150 may additionally include instructions for causing the configuration data/code to be executed on the remote device and determining that the device has transitioned into a different state by accessing the device. Additionally, the AER application 150 may include instructions for updating the electronic object to reflect the different state.

The one or more user interfaces 160 may include one or more suitable types of user input devices, such as integrated and/or external keyboards, touch screen displays, microphones, touch pads, mice, and/or any suitable types of remote and/or local user input devices, along with associated software and/or firmware. The one or more user interfaces 160 may include one or suitable types of output devices, such as displays (which may include touch screen displays), speakers, and the like, along with associated software and/or firmware. For example, the user interface 160 may be integrated with a display of the client computing device 102, an external server computer, a mobile computing device, or another suitable computing device. The one or more user interfaces 160 may include one or more local interfaces, and/or may include one or more remote interfaces that are communicatively connected to the client computing device 102 via a network (e.g., that are provided by an application, client, web browser, or other software executing on a personal electronic device (PED), laptop, tablet, or another computing device). For ease of reading (and not limitation) purposes, the one or more user interface(s) 160 may be referred to herein using the singular tense.

The communication interface 162 includes at least one wireless communication interface which includes hardware, firmware, and/or software that is configured to communicate with other devices (including at least other mobile devices) and/or over a network, or with the two or more computing devices 108 and/or over the source network 104 and/or over the target network 106 (e.g., when retrieving network data; testing, evaluating, and/or validating the target network platform 116; etc.), using one or more wireless communication protocols. For example, the communication interfaces 162 may be configured to transmit and receive data using a Bluetooth protocol, a Wi-Fi® (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wireless communication protocols. The communication interfaces 162 may include one or more transceivers to support various different wireless communication protocols; however, as previously mentioned, for ease of reading (and not limitation purposes) herein, the one or more communication interfaces 162 may be referred to herein using the singular tense. Additionally, although not shown in FIG. 1, it is understood that, in some implementations, communication interfaces 162 may include one or more wired communication interfaces which may be utilized by the client computing device 102 to communicatively connect to the source network platform 114, the target network platform 116, the computing devices 108, and/or to other devices via one or more wired communications or data protocols.

In some embodiments, the communication interface 162 may be a network interface controller (NIC) and may include any suitable NICs, such as wired/wireless controllers (e.g., Ethernet controllers), and facilitate bidirectional/multiplexed networking over the source network 104, target network 106, and/or another network, between the client computing device 102 and other components of the environment 100 (e.g., the database 182, the computing devices 108, another client computing device, a remote computing device, etc.).

The one or more application programming interfaces (APIs) 180 may facilitate interaction between components and/or devices of the computing system 100. The APIs 180 may be configured to receive data, and/or information, from a component of the computing system 100 and to provide such data to a different component of the computing system 100. For example, the APIs 180 may be configured to enable the preprocessing module 142 to communicate with the prompting module 144. Specifically, the APIs 180 may enable the preprocessing module 142 to communicate extracted intent-revealing commands and additional network data to the prompting module 144. As another example, the APIs 180 may enable the prompting module 144 to communicate generated prompts (e.g., prompts generated based on the intent-revealing commands and additional network data) to the language model 146.

In some embodiments, the one or more APIs 180 may include a computer vision API 180 for interpreting visual data (e.g., image data, PDFs, etc.). For example, exemplary computer vision APIs may include a visual processing model/application, for instance, a convolutional neural network (CNN), an image-to-graph transformer, a graph neural network (GNN), a multilayer perceptron, etc. The computer vision API 180 may generate graph representations (e.g., a text file) of visual data, and may provide the graph representations to the one or more language models 146, thereby enabling the one or more language models 146 to interpret visual data (e.g., network topology diagrams stored on the database 110).

The one or more databases 182 may store a variety of data, including historical network configuration conversions (e.g., source network configurations and accurate/successful target network configurations), network topology diagrams, device/network specifications, protocol support information, additional network platform documentation/resources, etc. By maintaining this information in organized and accessible databases, the system can efficiently retrieve the data for supporting the conversion process. For example, the system can query the databases 182 to understand the capabilities of different network platforms, identify compatible protocols, and/or access templates for generating target network configurations. The database 182 may be communicatively connected (e.g., via a network or wired connection) to the client computing device 102, and/or another computing device of the system 100.

In some embodiments, the database 182 may use an information retrieval (IR) system, employing query-driven retrieval to obtain files that are responsive to a system query. While not explicitly depicted in FIG. 1, in some embodiments, the computing environment 100 may include an IR system, separate from the database 182. For example, the computing environment 100 may include, and/or access (e.g., via APIs 180), various IR systems including search engines, a vector database, a digital library, the database 182 etc., to obtain relevant network documentation/resources.

### Exemplary Network Topology Diagram

FIG. 2 depicts an exemplary network topology diagram 200 that includes four exemplary devices: IOSv-R1, IOSv-R2, IOSv-R3, and IOSv-R4. Additionally, it should be understood that the exemplary network topology diagram 200 is a mere example of a potential network configuration (e.g., a target network configuration/platform or a source network configuration/platform; such as, the source network platform 114 or target network platform 116 of FIG. 1).

### Exemplary Computer Implemented Method

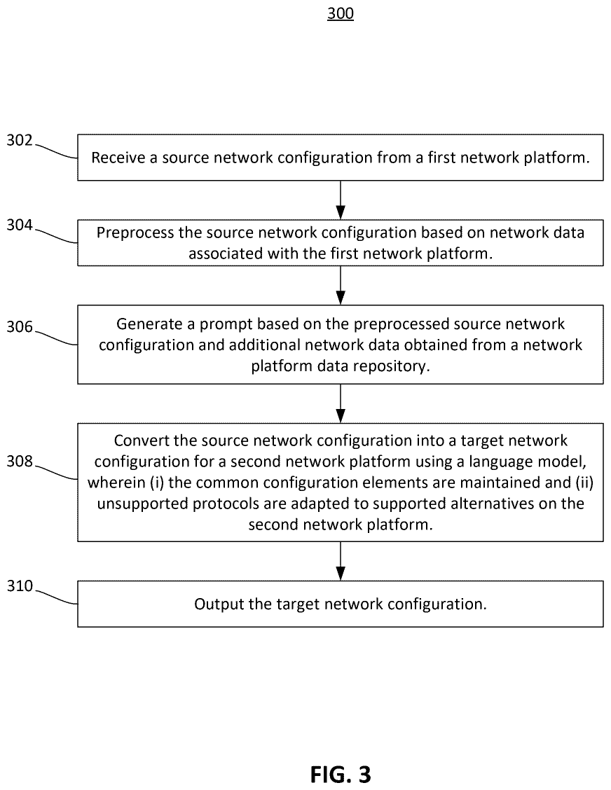

FIG. 3 is a flow diagram of an example computer-implemented method 300 for converting a source network configuration from a first network platform into a target network configuration for a second network platform using a language model. For example, an entity may need to transition from one network platform to another. The method 300 ensures that common configuration elements are maintained while unsupported protocols are adapted to supported alternatives on the second network platform. Additionally, the method 300 may be implemented by one or more processors of a computing system executing computer-readable instructions stored on one or more memories of the computing system (e.g., implemented by the computing environment 100, including the one or more processors 120 and the memories 140, of FIG. 1)

The method 300 may include receiving a source network configuration from a first network platform (block 302). This step involves obtaining the existing configurations of a network, which could be from various networking vendors such as Cisco, Juniper, Arista, or Aruba. For example, one or more devices may be configured for the first network platform and the computing system may obtain the source network configuration from such devices.

The method may include preprocessing the source network configuration based on network data obtained from one or more devices (e.g., the one or more computing devices 108 of FIG. 1) connected to the first network platform (block 304). Preprocessing the source network configuration may include executing intent-revealing commands on the one or more devices connected to the first network platform to obtain the network data. For example, the network data may include one or more of routing protocols, access control lists, interface configurations, a running network configuration(s), etc. The executed intent-revealing commands allow the language model to develop an understanding of the intended use and setup of the original network configuration, beyond just the basic configuration details. For example, preprocessing the source network configuration may involve analyzing outputs of commands like ‘show running-config’, ‘show interfaces’, ‘show protocols’, etc., which reveal the active states of configurations, interfaces, or protocols, for example, and reveal other critical network details.

The method may include generating a prompt based on the preprocessed source network configuration and additional network data obtained from a network platform data repository (block 306). For example, generating the prompt may include creating a structured query or set of instructions that can guide the language model in converting the source network configuration accurately. Additionally, the method may include obtaining the additional network data from the network platform data repository based on source network configuration and/or the network data obtained from the one or more devices connected to the network. The additional network data may include platform specific network configurations, network diagrams (e.g., network topology diagrams, such as, the exemplary network topology diagram 200 of FIG. 2), and/or the like, thereby providing a comprehensive view of the network's current state and intended use case for the language model. This additional data enriches the context for the language model, enabling more accurate and relevant conversions, and generating a prompt based on the preprocessed network configuration and the additional network data allows the model to make informed decisions during the conversion process.

The method may include converting, by a language model, the source network configuration into a target network configuration for a second network platform by inputting the prompt into the language model (block 308). Additionally, converting the source network configuration includes: maintaining common configuration elements between the platforms (e.g., the source network platform and the target network platform) and adapting unsupported protocols to supported alternatives on the second network platform.

The method may include outputting the target network configuration (block 310). The target network configuration provides the user with a new network configuration that is compatible with the second network platform, and incorporates any modifications or alternative solutions for unsupported protocols from the first network platform.

The method 300 may include generating alternative solutions for protocols not supported on the second network platform. Moreover, protocols in/of the source network configuration that are not compatible with the target network platform are identified and viable alternatives may be proposed. The alternative solutions ensure the functionality of the network post-conversion, especially when dealing with protocols like EIGRP, which may not be supported across all platforms.

The method 300 may include validating the target network configuration against the specifications of the second network platform. Validating the target network configuration may include determining that the converted configuration adheres to the technical and operational requirements of the target network platform specifications, minimizing the risk of errors or compatibility issues. For example, the specifications of a network platform may include hardware requirements (e.g., routers, servers, etc.), software requirements (e.g., specific operating systems), security requirements (e.g., encryption, access controls, etc.), performance requirements (e.g., bandwidth, latency, etc.), etc.

The method 300 may include receiving, via graphical user interface, modifications to the target network configuration and incorporating, by the language model, the modifications into the target network configuration by inputting an additional prompt including the modifications to the language model. Moreover, converting the source network configuration includes interacting with a user in a conversational format. The additional prompt may be generated based upon the received modifications, and/or the received modifications may be interpolated into a template modifications prompt that includes a set of instructions for guiding the model when incorporating the modifications into the target network configuration. An interactive approach that allows users to specify changes or additions to the network setup during the conversion process, such as adding new interfaces or VLANs, ensures that the final configuration meets their specific needs.

### Exemplary Language Model Architecture

FIG. 4 depicts an exemplary large language model architecture 400 for processing and understanding natural language inputs, according to an aspect. The language model 402 may include embedding layers 412, a dropout layer 414, a transformer loop 416, a final normalization layer 417, and a linear output layer 418. In some embodiments, the embedding layers may include a positional embedding layer 412a and a token embedding layer 412b. The transformer loop 416 may be repeated N times and may include a normalization layer 420a, an attention layer 422, a dropout layer 424a, a normalization layer 420b, a dense layer 426, and a dropout layer 424a. Training text (e.g., the works of Shakespeare) may be tokenized to generated tokenized training text 430 for input to the language model 402. Additionally, the language model 402 operates in a high-dimensional space, or vector space, defined by the internal embeddings and weights of the language model 402 and the language model possesses a particular dimensionality based on the number of features this space. Moreover, the dimensionality of the language model 402 corresponds to the number of tokens that can be represented as a vector in this high-dimensional vector space.

The architecture 400 begins with the embedding layers 412 for converting input text into a format that the model can process. The positional embedding layer 412a may assign a unique position to each word in the input sequence, ensuring the model can recognize the order of words. The token embedding layer 412b may convert each word into a high-dimensional vector, capturing semantic information about the word.

Following the embedding layers, the dropout layer 414 may prevent overfitting by randomly omitting some of the features during training. This ensures that the model remains generalizable to new and unseen data. The core of the architecture is the transformer loop 416, which the model may repeat N times to deeply process the input data (e.g., tokenized training text 430). Within each iteration of the transformer loop, a normalization layer 420a may mitigate vanishing or exploding gradients. Additionally, the normalization layer 420a may ensure the input embeddings (e.g., from embedding layers 412a and 412b) fall within a reasonable range. The normalization layer 420a precedes an attention layer 422 (e.g., attention mechanism 510 of FIG. 5), which may provide the language model 402 with a means for focusing on different parts of the input sequence (e.g., tokenized training text 430) for better understanding. In some embodiments, the attention layer 422 is followed by another dropout layer 424a, which may further aid in generalizing the model for new and unseen data. A second normalization layer 420b and a dense layer 426 succeed the dropout layer 424a, providing additional processing and transformation of the data. The dense layer 426, or a fully connected layer 426, may convert the dimensionality of the output of the model. In some embodiments, the final dropout layer 424b may provide additional robustness and generalization of the model before the loop repeats or concludes.

After exiting the transformer loop, the model may apply a final normalization layer 417 to stabilize the learned features of the tokenized training text 430. The linear output layer 418 may then converts these features into a format suitable for the specific task at hand, such as classification or text generation. Moreover, the linear output layer 418 produces the predictions of the language model 402 based on the processed set of instructions provided to the language model 402. In some embodiments, although not depicted explicitly in FIG. 4, the language model 402 may include an instructions layer. The instructions layer may process a set of instructions input to the language model 402 and prioritize an instruction in the set over a conflicting instruction based on the relevance and importance of the conflicting instructions.

In operation, users or automated systems may input text into the language model 402. The text may then undergo processing through the described layers (e.g., embedding layers 412, normalization layers 420a-420b, dropout layers 424a-424b, attention layer 422, dense layer 426, etc.) of the language model 402. The language model architecture 400 supports a wide range of natural language processing tasks, enabling it to generate responses, classify text, or even predict subsequent words in a sequence. Users can interact with the language model 402 through various computing environments such as the computing environment 100 of FIG. 1 (e.g., via a graphical user interface). The flexibility and depth of processing provided by the language model architecture 400 makes it suitable for complex language understanding and generation tasks, offering significant utility in applications such as personal assistants, chatbots, content creation tools, and more.

### Exemplary Language Model Block Flow Diagram

FIG. 5 depicts an exemplary block flow diagram 500 for developing a configuration conversion assistant 501, according to some aspects. In many embodiments, the configuration conversion assistant 501 may be a language model (LM) such as a large language model (LLM). Building an LLM may include implementing a model architecture 504, data preparation and sampling 506, and pretraining 508, as depicted at block 502. The present techniques may include training one or more LMs and/or LLM to predict the next word, or token, in a sequence of words/tokens.

The language model architecture 504 (e.g., the structural design and/or framework of a model) may be selected based upon the intended use case of the language model. For example, the language model architecture 504 may be a transformer architecture, a bidirectional encoder representations from transformers (BERT) architecture, another suitable architecture, or a suitable architecture not yet contemplated in the art.

Data preparation and sampling 506 may include collecting organized and diverse datasets (e.g., massive corpuses of data from the internet or another vast data source) of high quality for training the language model to predict the next token in a sequence of tokens. Exposing a language model to varying linguistic patterns and linguistic nuances may improve the language model's ability to understand and/or analyze input data and may, consequently, improve the language model's ability to generate accurate responses (e.g., accurate text responses).

Pretraining 508 may include training a language model on organized and diverse datasets (e.g., the data from data preparation and sampling 506) such that the language model learns general natural language patterns and nuances. Pretraining 508 may additionally include implementing an attention mechanism 510 (e.g., the attention layer 422 of FIG. 4) to provide the language model with improved contextual understanding. Moreover, pretraining 508 converts a language model to a foundational model with a strong understanding of natural language.

The attention mechanism 510 allows a language model to look backwards and forwards (across the token window) when predicting the next token in a sequence and allows the language model to focus on certain types of data (e.g., data that is relevant to the particular application and/or use case of the language model). For example, the attention mechanism 510 may assign a level of importance (e.g., weights) to elements of input data (e.g., words in a sentence). As another example, a self-attention mechanism 510 allows a language model to focus on portions of an input sequence and consider dependencies across the sequence. Additionally, a language model may include one or more attention mechanisms 510, or attention heads 510, allowing the language model to consider local and global context. Moreover, the attention mechanism 510 may provide a language model with the ability to selectively focus on relevant elements of input data while placing less emphasis on other elements of the input data. In contrast, machine learning models/techniques such as recurrent neural networks (RNNs), convolutional neural networks (CNNs), etc., have limited context windows, and consequently struggle to achieve the broad contextual understanding of an input sequence provided by attention mechanism 510. In some embodiments, another learning mechanism, besides the attention mechanism 510, may be implemented to provide the language model with the ability to consider positions of tokens in a sequence, such as a positional encoding mechanism.

Developing a configuration conversion assistant 501 may include training 514 and model evaluation 516 of a foundation model, as depicted at block 512. In some embodiments, pretrained weights 518 may be loaded into a language model. Training 514 may include inputting data to a foundation model to generate response/outputs, calculating a loss based on comparing the models output to ground truth data (e.g., labeled input data), identifying gradients of trainable weights in the model with respect to the calculated loss (e.g., the rate of change of a loss function with respect to the model's weights), and optimizing the model's performance to minimize the loss by updating the weights of the model based on the identified gradients. Model evaluation 516 may include evaluating the performance of a foundational model using a validation dataset (e.g., a dataset not included in the training data used to train the model). Moreover, validation loss may be compared to training loss (e.g., the calculated loss above) in model evaluation 516. For example, validation loss of the model exceeding the training loss may be an indication that the language model is overfitting to the training data. In some embodiments, pretrained weights 518 may be loaded into a large language model and may provide a computationally efficient approach/alternative to pretraining a large language model to generate a foundational model.

Finetuning 520 may include training (e.g., via one or more language model training applications stored on the memories 140 of the client computing device 102 depicted in FIG. 1) the foundational model on key value pairs (e.g., inputs and desired outputs) such that the foundational model learns to predict a desired output. Finetuning 520 may include adjusting and/or training the final layers of a foundational model. A foundational model may already excel at understanding language and performing natural language oriented tasks. Moreover, by updating the final layers of the foundational model (e.g., leaving the rest of the model frozen while the final layers are trained on task specific data) the contextual understanding of a trained foundational model may be preserved while improving the foundation models performance in the specific task at hand. Additionally, training only the final layers of a foundational model may be less computationally expensive then training the entire model. Additionally and/or alternatively, finetuning 520 may include training all layers of the model on task specific data. In some embodiments, training or finetuning the entirety of a foundational model on task specific data, as opposed to training the final layers of the model, may provide improved performance. For example, finetuning 520 may include training the foundation model on documentation and specifications of one or more networking vendors (e.g., Cisco, HP, Juniper, Aruba, Palo Alto, Extreme, etc.), such as protocol commands specific to the vendors, thereby creating one or more finetuned models that can advantageously analyze prompted intent and supported device syntax more accurately than generic models.

The configuration conversion assistant 501 may be generated by finetuning (e.g., finetuning 520) a foundational model. Moreover, the configuration conversion assistant 501 may be a foundational model (e.g., GPT-4, LaMDA, LLaMa, etc.) finetuned on successful platform configuration conversions (e.g., a training source network configurations and an accurate target network configurations) and additional relevant network configuration data/documentation.

An instructions dataset 524, or prompts 524, may include natural language instructions and input data for the configuration conversion assistant 501 that cause the configuration conversion assistant 501 to process input data (e.g., in a particular manner described in the instructions dataset 524) and generate a desired output. In some embodiments, key values pairs may be provided within the instructions dataset 524, often termed one shot training. In such embodiments, while the foundational model may not technically be finetuned, one shot training may provide further task-specific context and understanding to the foundational model (e.g., similar to finetuning 520). Moreover and in some embodiments, the configuration conversion assistant 501 may be a foundational model (e.g., a foundational model that has not been finetuned) and key value pairs (e.g., example source network configurations scripts/data and example target network configurations scripts/data) may be integrated into the instructions dataset 524 for input to the foundational model.

Prompt engineering may provide additional task specific context and understanding to the configuration conversion assistant 501. For example, in embodiments where the configuration conversion assistant 501 is a foundational model that has not been finetuned, prompt engineering may provide a computationally efficient alternative, or supplement, to finetuning a foundational model. Moreover, a foundational model may effectively by finetuned by providing task specific instructions within natural language prompts (e.g., instructions dataset 524) to the foundational model. Various prompt engineering styles may provide improved performance to the configuration conversion assistant 501. For example, chain of thought prompting includes instructing a large language model to reach intermediate conclusions (e.g., that may be individually validated) and output such intermediate conclusions in combination with the generated response to the prompt. Such an approach may result in improved results/outputs from large language models, as reaching intermediate conclusions may provide additional context for the model when generating the final output. As another example, iterative prompting may include adjusting a prompt based on the accuracy of the generated output in response to the prompt thereby iteratively refining the prompt. Moreover, prompt engineering may provide the configuration conversion assistant 501, and/or a foundational model, with additional task-specific context and refined instructions that augment the model's ability to generate accurate responses.

### Exemplary Automated Cross Platform Support

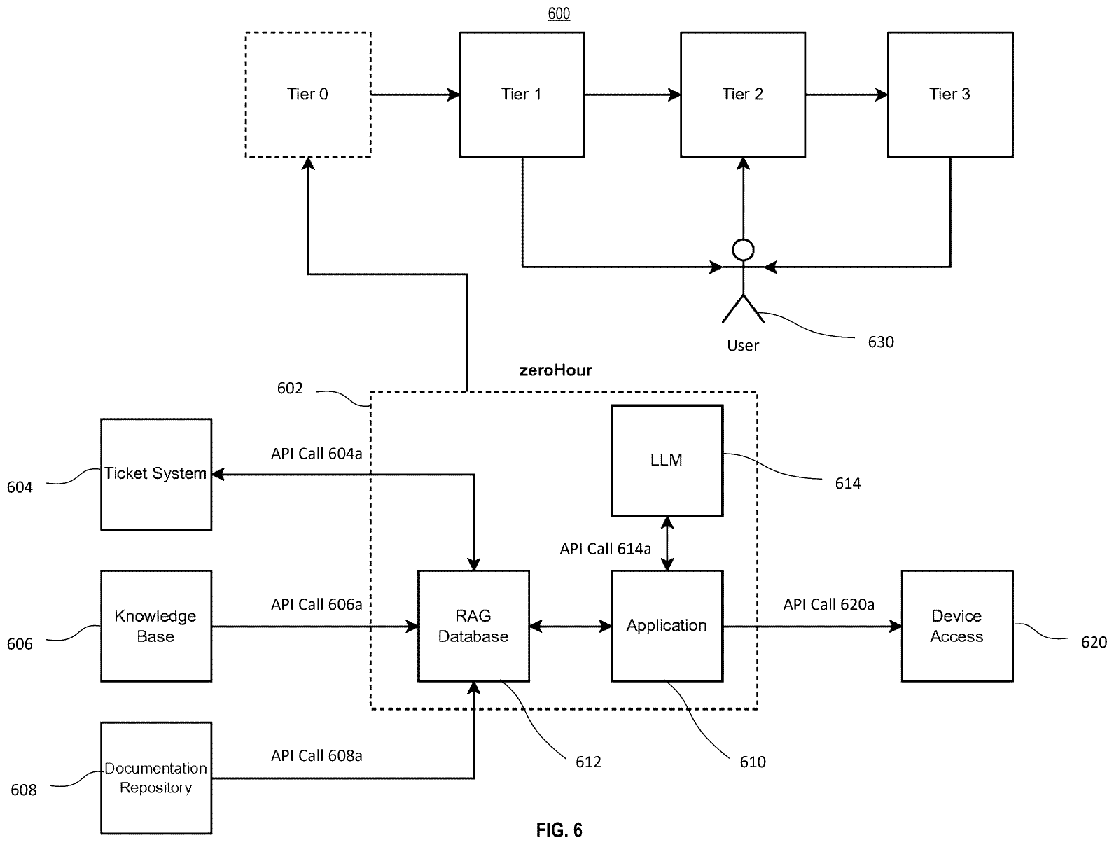

FIG. 6 depicts an exemplary block flow diagram 600 for automated cross platform support and automated error resolution.

The block flow diagram 600 includes an automated error resolution (AER) module 602, a centralized database 604, a knowledge base 606, and a documentation repository 608. The AER module 602 (or zeroHour application) may include an automated error resolution (AER) application 610, a retrieval augmented generation (RAG) database 612, and a large language model (LLM) 614 (e.g., language model 142 of FIG. 1, language model 204 of FIG. 2, cross platform support assistant 601 of FIG. 6, and/or language model 602 of FIG. 6).

The RAG database 612 (e.g., database 110 of FIG. 1) may be communicatively coupled to the AER application 610. The RAG database 612 may communicatively interface with the centralized database 604 (e.g., a centralized database storing electronic objects, such as an electronic ticketing system), via an API call (line 604a; e.g., via troubleshooting APIs 180 of FIG. 1), such that the RAG database 612 can obtain electronic objects (e.g., an electronic trouble ticket), or information/data related to electronic objects stored on the centralized database 604, from the centralized database 604 and provide information/data to the centralized database 604. Additionally, the RAG database 612 may be populated with information/data from the knowledge base 606, via an API call (line 606a; e.g., via troubleshooting APIs 180 of FIG. 1), and the RAG database 612 may obtain documents and other data from the documentation repository 608, via an API call (line 608a; e.g., via troubleshooting APIs 180 of FIG. 1).

The AER application 610 (e.g., AER application 150 of FIG. 1) may access remote devices (block 620; e.g., device(s) 104 of FIG. 1) to detect an exception/failure state of one or more remote devices by monitoring log files and/or device states directly, the AER application 610 may access the remote devices via an API call (line 620a; e.g., via troubleshooting APIs 180 of FIG. 1). Additionally, the AER application 610 may communicate with the LLM 614, via an API call (line 614a; e.g., via troubleshooting APIs 180 of FIG. 1). For instance, the AER application 610 may provide log files, device states, and/or data from the RAG database 612 to the LLM 614.

Based on an electronic object from the centralized database 604, the AER application 610 may perform a semantic search in the RAG database 612. The AER application 610 may then query the LLM 614 with the data returned from the RAG database 612 to perform a preliminary analysis on the electronic object (via the LLM 614). The AER application 610 may then access/interface with a remote device(s) (e.g., block 620; and via an API call), to obtain log files and/or device states to detect an exception/failure state of the remote device(s). Based on the electronic object and the detected exception/failure state, the LLM 614 and/or the AER application 610 may construe whether the electronic object corresponds to the detected exception/failure state of the remote device. The LLM 614 may then determine a fix for the exception/failure state and generate configuration data/code (e.g., troubleshooting steps/commands) that will be run on the remote device to effect a repair/change that causes the failing remote device to transition into a non-fail state. The AER application 610 may then cause the remote device to execute the configuration code/data generated by the LLM 614. Based on additional log files and/or device states obtained (e.g., via an API call) by the AER application 610 from the remote device, the AER application 610 and/or the LLM 614 may determine whether the device has transitioned into a different state. The AER application 610 may then update the electronic object to reflect the different state of the remote device. In some embodiments, the electronic object may also be updated with suggested next steps and/or associated documentation (e.g., from the documentation repository). The updated electronic object may be populated into the RAG database 612 to supplement or provide additional context for continuous learning.

The block flow diagram 600 additionally depicts 4 issue tiers (Tier 0, Tier 1, Tier 2, and Tier 3) and a user 630. The AER module 602 operates within Tier 0, while more complex issues (Tier 1, Tier 2, and Tier 3) are handled by the user 630. However, in some embodiments, the AER module 602 may be tasked with addressing issues that fall within any of Tiers 0-3. Moreover, all electronic objects from the centralized database 604 may first be analyzed/handled by the AER module 602, and upon a determination that the remote device experiencing an issue has not transitioned to a success/active state the user 630 may be tasked with resolving the issue (e.g., using the tools/interfaces depicted in FIG. 3A and FIG. 3B).

### Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system comprising: one or more processors; and one or more memories having stored thereon computer-executable instructions that, when executed by the one or more processors, cause the computing system to: receive a source network configuration from a first network platform; preprocess the source network configuration based on network data obtained from one or more devices connected to the first network platform; generate a prompt based on the preprocessed source network configuration and additional network data obtained from a network platform data repository; convert, by a language model, the source network configuration into a target network configuration for a second network platform by inputting the prompt into the language model, wherein (i) common configuration elements are maintained and (ii) unsupported protocols are adapted to supported alternatives on the second network platform; and output the target network configuration.
2. The computing system of aspect 1, further comprising instructions that, when executed by the one or more processors, cause the computing system to: obtain the additional network data from the network platform data repository, the additional network data including one or more of: platform specific network configurations or network diagrams.
3. The computing system of any of aspects 1-2, wherein the network diagrams are indicative of one or more intended use cases of the source network configuration.
4. The computing system of any of aspects 1-3, wherein preprocessing the source network configuration includes executing intent-revealing commands on the one or more devices connected to the first network platform to obtain the network data, the network data including one or more of: routing protocols, access control lists, interface configurations, or a running network configuration.
5. The computing system of any of aspects 1-4, further comprising instructions that, when executed by the one or more processors, cause the computing system to: generate alternative solutions for protocols not supported on the second network platform.
6. The computing system of any of aspects 1-5, further comprising instructions that, when executed by the one or more processors, cause the computing system to: validate the target network configuration against specifications of the second network platform.
7. The computing system of any of aspects 1-6, wherein converting the source network configuration includes interacting with a user in a conversational format, and further comprising instructions that, when executed by the one or more processors, cause the computing system to: receive, via graphical user interface, modifications to the target network configuration; and incorporate, by the language model, the modifications into the target network configuration by inputting an additional prompt including the modifications to the language model.
8. A computer-implemented method comprising: receiving a source network configuration from a first network platform; preprocessing the source network configuration based on network data obtained from one or more devices connected to the first network platform; generating a prompt based on the preprocessed source network configuration and additional network data obtained from a network platform data repository; converting, by a language model the source network configuration into a target network configuration for a second network platform by inputting the prompt into the language model, wherein (i) common configuration elements are maintained and (ii) unsupported protocols are adapted to supported alternatives on the second network platform; and outputting the target network configuration.
9. The method of aspect 8, further comprising: obtaining the additional network data from the network platform data repository, the additional network data including one or more of: platform specific network configurations or network diagrams.
10. The method of any of aspects 8-9, wherein preprocessing the source network configuration includes executing intent-revealing commands on the one or more devices connected to the first network platform to obtain the network data, the network data including one or more of: routing protocols, access control lists, interface configurations, or a running network configuration.
11. The method of any of aspects 8-10, further comprising: generating alternative solutions for protocols not supported on the second network platform.
12. The method of any of aspects 8-11, further comprising: validating the target network configuration against specifications of the second network platform.
13. The method of any of aspects 8-12, wherein converting the source network configuration includes interacting with a user in a conversational format, and the method further comprising: receiving, via a graphical user interface, modifications to the target network configuration; and incorporating, by the language model, the modifications into the target network configuration by inputting an additional prompt including the modifications to the language model.
14. A non-transitory computer-readable medium having stored thereon instructions that, when executed by one or more processors of a computing system, cause the computing system to: receive a source network configuration from a first network platform; preprocess the source network configuration based on network data obtained from one or more devices connected to the first network platform; generate a prompt based on the preprocessed source network configuration and additional network data obtained from a network platform data repository; convert, by a language model, the source network configuration into a target network configuration for a second network platform by inputting the prompt into the language model, wherein (i) common configuration elements are maintained and (ii) unsupported protocols are adapted to supported alternatives on the second network platform; and output the target network configuration.
15. The non-transitory computer-readable medium of aspect 14, including further instructions that, when executed by the one or more processors, cause the computing system to: obtain the additional network data from the network platform data repository, the additional network data including one or more of: platform specific network configurations or network diagrams.
16. The non-transitory computer-readable medium of any of aspects 14-15, wherein the network diagrams are indicative of one or more intended use cases of the source network configuration.
17. The non-transitory computer-readable medium of any of aspects 14-16, wherein preprocessing the source network configuration includes executing intent-revealing commands on the one or more devices connected to the first network platform to obtain the network data, the network data including one or more of: routing protocols, access control lists, interface configurations, or a running network configuration.
18. The non-transitory computer-readable medium of any of aspects 14-17, including further instructions that, when executed by the one or more processors, cause the computing system to: generate alternative solutions for protocols not supported on the second network platform.
19. The non-transitory computer-readable medium of any of aspects 14-18, including further instructions that, when executed by the one or more processors, cause the computing system to: validate the target network configuration against specifications of the second network platform.

20. The non-transitory computer-readable medium of any of aspects 14-19, wherein converting the source network configuration includes interacting with a user in a conversational format, and the non-transitory computer-readable medium including further instructions that, when executed by the one or more processors, cause the computing system to: receive, via a graphical user interface, modifications to the target network configuration; and incorporate, by the language model, the modifications into the target network configuration by inputting an additional prompt including the modifications to the language model.

### ADDITIONAL CONSIDERATIONS

The following considerations also apply to the foregoing discussion. Although the following text sets forth a detailed description of numerous different aspects, it should be understood that the legal scope of the invention may be defined by the words of the claims set forth at the end of this patent. The detailed description is to be construed as exemplary only and does not describe every possible aspect, as describing every possible aspect would be impractical, if not impossible. One could implement numerous alternate aspects, using either current technology or technology developed after the filing date of this patent, which would still fall within the scope of the claims.

Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computing system comprising:
one or more processors; and
one or more memories having stored thereon computer-executable instructions that, when executed by the one or more processors, cause the computing system to:
receive a source network configuration from a first network platform;
preprocess the source network configuration based on network data obtained from one or more devices connected to the first network platform;
generate a prompt based on the preprocessed source network configuration and additional network data obtained from a network platform data repository;
convert, by a language model, the source network configuration into a target network configuration for a second network platform by inputting the prompt into the language model,
wherein (i) common configuration elements are maintained and (ii) unsupported protocols are adapted to supported alternatives on the second network platform; and
output the target network configuration.

2. The computing system of claim 1, further comprising instructions that, when executed by the one or more processors, cause the computing system to:
obtain the additional network data from the network platform data repository, the additional network data including one or more of: platform specific network configurations or network diagrams.

3. The computing system of claim 2, wherein the network diagrams are indicative of one or more intended use cases of the source network configuration.

4. The computing system of claim 1, wherein preprocessing the source network configuration includes executing intent-revealing commands on the one or more devices connected to the first network platform to obtain the network data, the network data including one or more of:
routing protocols,
access control lists,
interface configurations, or
a running network configuration.

5. The computing system of claim 1, further comprising instructions that, when executed by the one or more processors, cause the computing system to:
generate alternative solutions for protocols not supported on the second network platform.

6. The computing system of claim 1, further comprising instructions that, when executed by the one or more processors, cause the computing system to:
validate the target network configuration against specifications of the second network platform.

7. The computing system of claim 1, wherein converting the source network configuration includes interacting with a user in a conversational format, and
further comprising instructions that, when executed by the one or more processors, cause the computing system to:
receive, via graphical user interface, modifications to the target network configuration; and
incorporate, by the language model, the modifications into the target network configuration by inputting an additional prompt including the modifications to the language model.

8. A computer-implemented method comprising:
receiving a source network configuration from a first network platform;
preprocessing the source network configuration based on network data obtained from one or more devices connected to the first network platform;
generating a prompt based on the preprocessed source network configuration and additional network data obtained from a network platform data repository;
converting, by a language model the source network configuration into a target network configuration for a second network platform by inputting the prompt into the language model,
wherein (i) common configuration elements are maintained and (ii) unsupported protocols are adapted to supported alternatives on the second network platform; and
outputting the target network configuration.

9. The method of claim 8, further comprising:
obtaining the additional network data from the network platform data repository, the additional network data including one or more of: platform specific network configurations or network diagrams.

10. The method of claim 8, wherein preprocessing the source network configuration includes executing intent-revealing commands on the one or more devices connected to the first network platform to obtain the network data, the network data including one or more of:
routing protocols,
access control lists,
interface configurations, or
a running network configuration.

11. The method of claim 8, further comprising:
generating alternative solutions for protocols not supported on the second network platform.

12. The method of claim 8, further comprising:
validating the target network configuration against specifications of the second network platform.

13. The method of claim 8, wherein converting the source network configuration includes interacting with a user in a conversational format, and the method further comprising:
receiving, via a graphical user interface, modifications to the target network configuration; and
incorporating, by the language model, the modifications into the target network configuration by inputting an additional prompt including the modifications to the language model.

14. A non-transitory computer-readable medium having stored thereon instructions that, when executed by one or more processors of a computing system, cause the computing system to:
receive a source network configuration from a first network platform;
preprocess the source network configuration based on network data obtained from one or more devices connected to the first network platform;
generate a prompt based on the preprocessed source network configuration and additional network data obtained from a network platform data repository;
convert, by a language model, the source network configuration into a target network configuration for a second network platform by inputting the prompt into the language model,
wherein (i) common configuration elements are maintained and (ii) unsupported protocols are adapted to supported alternatives on the second network platform; and
output the target network configuration.

15. The non-transitory computer-readable medium of claim 14, including further instructions that, when executed by the one or more processors, cause the computing system to:
obtain the additional network data from the network platform data repository, the additional network data including one or more of: platform specific network configurations or network diagrams.

16. The non-transitory computer-readable medium of claim 15, wherein the network diagrams are indicative of one or more intended use cases of the source network configuration.

17. The non-transitory computer-readable medium of claim 14, wherein preprocessing the source network configuration includes executing intent-revealing commands on the one or more devices connected to the first network platform to obtain the network data, the network data including one or more of:
routing protocols,
access control lists,
interface configurations, or
a running network configuration.

18. The non-transitory computer-readable medium of claim 14, including further instructions that, when executed by the one or more processors, cause the computing system to:
generate alternative solutions for protocols not supported on the second network platform.

19. The non-transitory computer-readable medium of claim 14, including further instructions that, when executed by the one or more processors, cause the computing system to:
validate the target network configuration against specifications of the second network platform.

20. The non-transitory computer-readable medium of claim 14, wherein converting the source network configuration includes interacting with a user in a conversational format, and the non-transitory computer-readable medium including further instructions that, when executed by the one or more processors, cause the computing system to:
receive, via a graphical user interface, modifications to the target network configuration; and
incorporate, by the language model, the modifications into the target network configuration by inputting an additional prompt including the modifications to the language model.
